(19) United States
(12) Patent Application Publication
(10) Pub. No.: US 2013/0023135 A1
(43) Pub. Date: Jan. 24, 2013

(54) TERMINAL HOUSING APPARATUS AND ELECTRONIC APPLIANCE

(71) Applicants: Noboru NAKAMURA, Saitama (JP); Yuki Okutome, Tokyo (JP)

(72) Inventors: Noboru NAKAMURA, Saitama (JP); Yuki Okutome, Tokyo (JP)

(73) Assignee: Sony Corporation, Tokyo (JP)

(21) Appl. No.: 13/494,403

(22) Filed: Jun. 12, 2012

(30) Foreign Application Priority Data
Jul. 22, 2011 (JP) 2011-160423

(51) Int. Cl. H01R 13/62

(52) U.S. Cl. 439/153

(57) ABSTRACT

There is provided a terminal housing apparatus including: a housing portion that is provided with an opening and houses a terminal; a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion; and an operation portion that engages the terminal operating lever and is operable to rotate the terminal operating lever when operated by the user.

### BACKGROUND

The present disclosure relates to a terminal housing apparatus housing a terminal and an electronic appliance equipped with a terminal housing apparatus.

In recent years, electronic appliances (such as audio appliances and USB memories) equipped with a terminal standardized according to USB (Universal Serial Bus) or the like have become widespread, thereby facilitating the reading out, storage, and the like of data (see Japanese Laid-Open Patent Publication No. 2010-218082).

### SUMMARY

As disclosed in the cited publication, in an electronic appliance equipped with a terminal such as a USB terminal, the terminal is typically fixed so as to be exposed to the outside and has a removable cover attached thereto to protect the terminal.

However, with a configuration where the terminal is protected with a removable cover, it is necessary to remove the cover whenever the electronic appliance is used and to attach the cover after use. Removing and attaching the cover is very troublesome for users. With a configuration where the cover is removable, there is also the risk of the cover being lost.

Accordingly, the present disclosure aims to provide a terminal housing apparatus and an electronic appliance where a terminal can be easily extended and retracted.

In order to solve the above issues, according to the present technology, there is provided a terminal housing apparatus including a housing portion that is provided with an opening and houses a terminal, a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion, and an operation portion that engages the terminal operating lever and is operable to rotate the terminal operating lever when operated by a user.

Further, according to the present technology, there is provided an electronic appliance including a terminal housing apparatus including a housing portion that is provided with an opening for extending and retracting a terminal and houses the terminal, a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion, and an operation portion that engages the terminal operating lever and is operable to rotate the terminal operating lever when operated by a user, and a case housing the terminal housing apparatus.

According to the present disclosure, it is possible to easily extend and retract a terminal.

### BRIEF DESCRIPTION OF THE DRAWINGS

FIGS. 1A and 1B are views showing the external configuration of an electronic appliance equipped with a terminal housing apparatus according to the present disclosure;

FIG. 2A is a perspective view showing the external configuration of a terminal, FIG. 2B is a side view of the terminal; and FIG. 2C is a plan view of the terminal;

FIG. 3A and FIG. 3B are perspective views of a terminal housing apparatus;

FIG. 4A is a bottom view of the terminal housing apparatus, and FIGS. 4B and 4C are views showing an engaged state of the terminal and a terminal operating lever;

FIG. 5A is a top view of the terminal housing apparatus, FIG. 5B is a side view of the terminal housing apparatus, and FIG. 5C is a bottom view of the terminal housing apparatus;

FIGS. 6A, 6B, and 6C are side views of the terminal housing apparatus;

FIGS. 7A and 7B are partial enlarged views of an electronic appliance equipped with the terminal housing apparatus;

FIGS. 8A to 8D are bottom views of the terminal housing apparatus useful in explaining the operation of the terminal housing apparatus;

FIGS. 9A, 9B, and 9C are side views of the terminal housing apparatus useful in explaining the operation of the terminal housing apparatus;

FIGS. 10A and 10B are perspective cross-sectional views of an electronic appliance showing a storage state of a cover; and

FIGS. 11A and 11B are diagrams useful in explaining the operation of the terminal housing apparatus in a state where a force is applied from outside onto the terminal.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present disclosure will now be described in detail with reference to the drawings. However, the present disclosure is not limited to the following embodiments. Note that the description is given in the order indicated below.

### 1. Embodiments

1-1. Configuration of Electronic Appliance

1-2. Configuration of Terminal Housing Apparatus

1-3. Operation of Terminal Housing Apparatus

2. Modifications

1. Embodiments

1-1. Configuration of Electronic Appliance

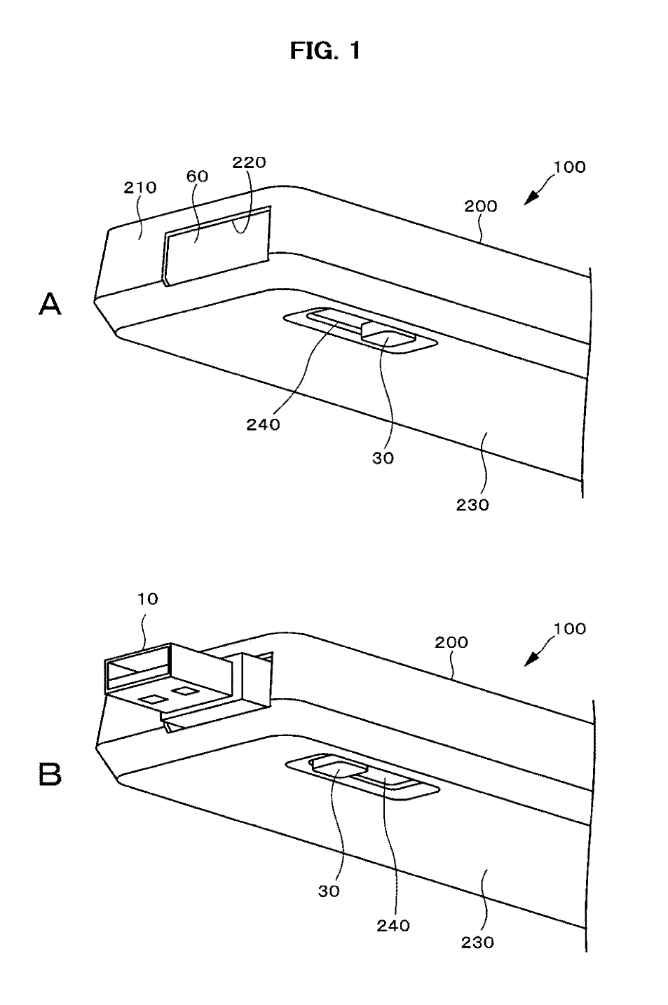

FIG. 1 is a diagram showing the external configuration of an electronic appliance 100 equipped with a terminal housing apparatus 300. In the present embodiment, the electronic appliance 100 is equipped with a terminal 10 that conforms to USB standard, is internally equipped with a nonvolatile memory (not shown) as a storage medium, and is configured as a so-called “USB memory”.

The electronic appliance 100 includes a case 200, the terminal 10, the terminal housing apparatus 300 according to the present embodiment provided inside the case 200, and the nonvolatile memory. The terminal 10 and the nonvolatile memory are electrically connected inside the case 200. Data inputted via the terminal 10 into the electronic appliance 100 from a peripheral device such as a personal computer is stored in the nonvolatile memory. Data stored in the nonvolatile memory is also outputted via the terminal 10 to a peripheral device such as a personal computer.

A terminal opening 220 for enabling the terminal 10 to extend and retract is formed in a front surface 210 of the case 200. When the terminal 10 is stored as shown in FIG. 1A, the terminal opening 220 is closed by a cover 60 that constructs the terminal housing apparatus 300. Meanwhile, when the terminal 10 protrudes outside the terminal 10, the cover 60 is open as shown in FIG. 1B. Note that the configuration of the cover 60 and an opening/closing operation of the cover 60 will be described in detail later. Note also that the case 200 is made for example of a synthetic resin, such as plastic.

Also, a tab exposure hole 240 for exposing a tab 30 that is operated when the user extends and stores the terminal 10 is formed in a lower surface 230 of the electronic appliance 100. To enable the tab 30 to slide, the tab exposure hole 240 is formed in a rectangular shape with a specified length along the length direction of the case 200 that is the direction in which the terminal 10 is operated.

### 1-2. Configuration of Terminal Housing Apparatus

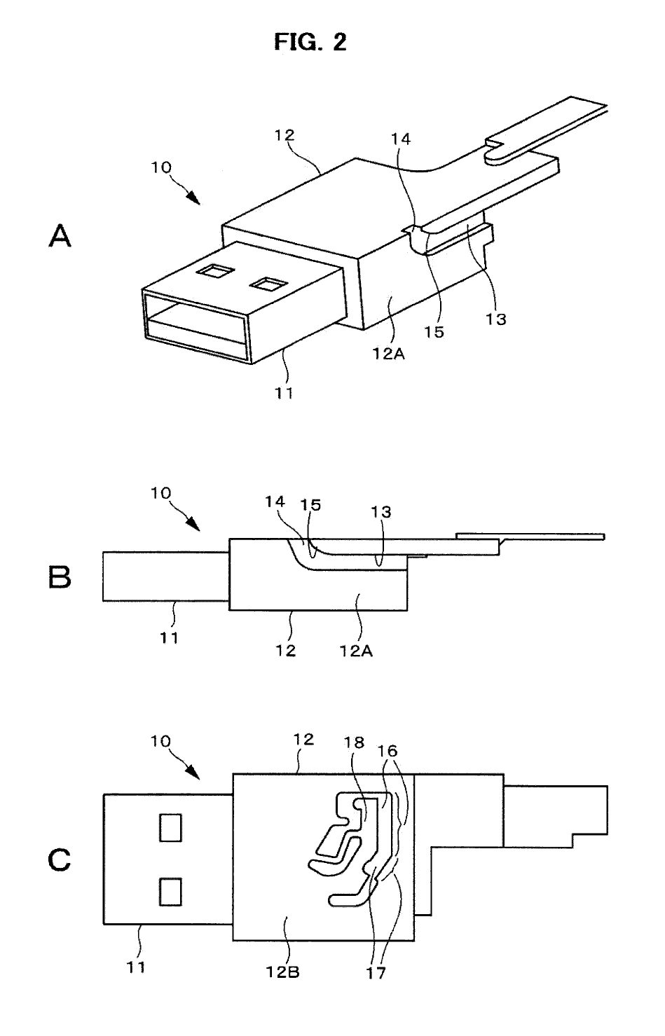

Next, the configuration of the terminal housing apparatus 300 provided inside the case 200 of the electronic appliance 100 will be described. FIG. 2A is a perspective view showing the external configuration of the terminal 10 housed in the terminal housing apparatus 300. FIG. 2B is a side view of the terminal 10 and FIG. 2C is a bottom view of the terminal 10.

In the present embodiment, the terminal 10 includes a terminal body 11 that conforms to USB standard and a cover portion 12 that covers the terminal body 11. When the terminal 10 is connected to another electronic appliance 100, the cover portion 12 covers a part aside from an inserted part of the terminal body 11 that is inserted into the other electronic appliance 100. As one example, the cover portion 12 is made of synthetic resin, such as plastic.

As shown in FIG. 2B, a cover lever engagement groove 13, which engages a cover lever protrusion 73 provided on a cover lever 70, described later, and allows the cover lever protrusion 73 to slide, is formed in a side surface 12A of the cover portion 12. The cover lever engagement groove 13 is constructed as a long groove along the length direction of the terminal 10 that is the direction in which sliding operations of the terminal 10 are performed. A concave portion 14 that is upwardly concave is formed at one end of the cover lever engagement groove 13. A curved surface portion 15 formed as a curved surface is formed between the concave portion 14 and the cover lever engagement groove 13. Accordingly, the cover lever engagement groove 13, the curved surface portion 15, and the concave portion 14 form a substantially L-shaped groove in the side surface 12A of the cover portion 12. Although described in detail later, when the cover 60 that constructs the terminal housing apparatus 300 is in a closed state, the cover lever protrusion 73 is positioned in the concave portion 14.

As shown in FIG. 2C, a terminal lever engagement groove 16 for engaging a terminal engagement protrusion 42 provided on a terminal operating lever 40 described later is formed on a bottom surface 12B of the cover portion 12. The terminal lever engagement groove 16 corresponds to the “engagement groove” mentioned in the range of the patent claims. The terminal lever engagement groove 16 is formed as a groove that is substantially perpendicular to the length direction of the terminal 10 that is the direction in which sliding operations of the terminal 10 are performed. One end of the terminal lever engagement groove 16 is bent at an angle to the length direction of the terminal 10, with such bent portion functioning as a terminal lever fixing portion 17. A rib portion 18 is also provided on the bottom surface 12B of the cover portion 12. The functions of the terminal lever engagement groove 16, the terminal lever fixing portion 17, and the rib portion 18 will be described later in this specification.

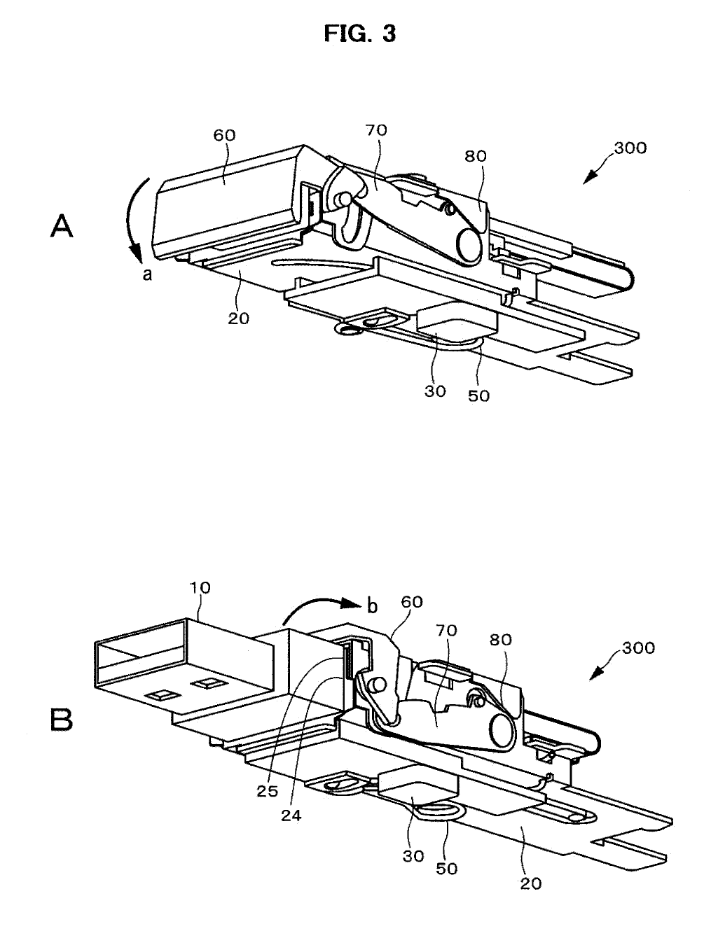

FIGS. 3A and 3B are perspective views showing the external configuration of the terminal housing apparatus 300. FIG. 3A shows a state where the terminal 10 is stored inside a housing portion 24 and FIG. 3B shows a state where the terminal 10 protrudes outside the housing portion 24.

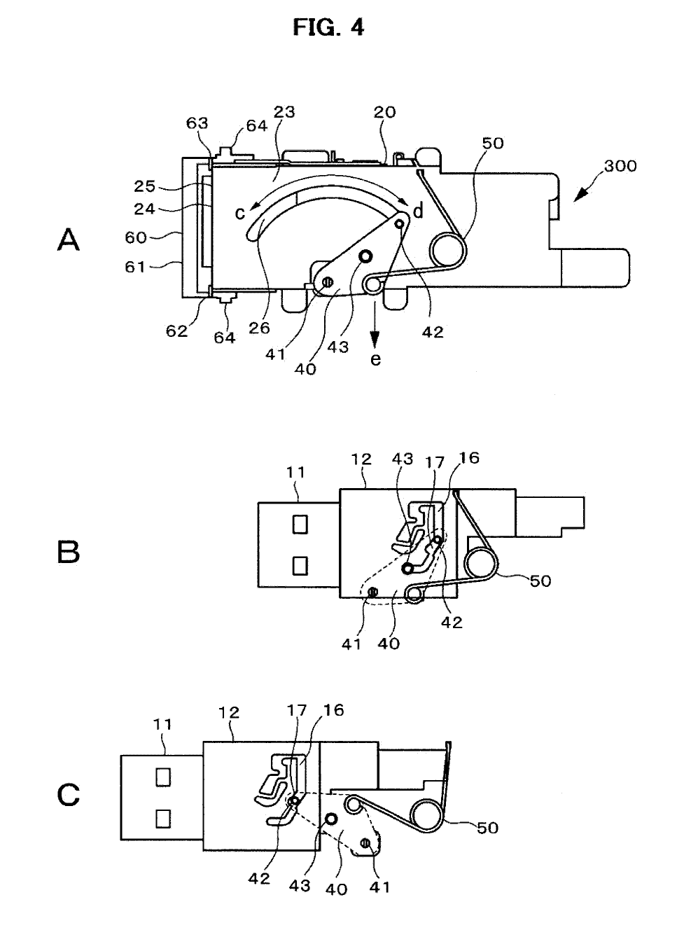

FIG. 4A is a bottom view of the terminal housing apparatus 300 in a state where, for ease of explanation, the tab 30 has been omitted. FIGS. 4B and 4C are views showing engagement between the terminal 10 and the terminal operating lever 40. FIG. 4B shows a state where the terminal 10 is stored inside the housing portion 24 and FIG. 4C shows a state where the terminal 10 protrudes outside the housing portion 24. Note that for ease of explanation, FIGS. 4B and 4C show only the terminal 10, the terminal operating lever 40, and a terminal spring 50, with the terminal depicted in a transparent state.

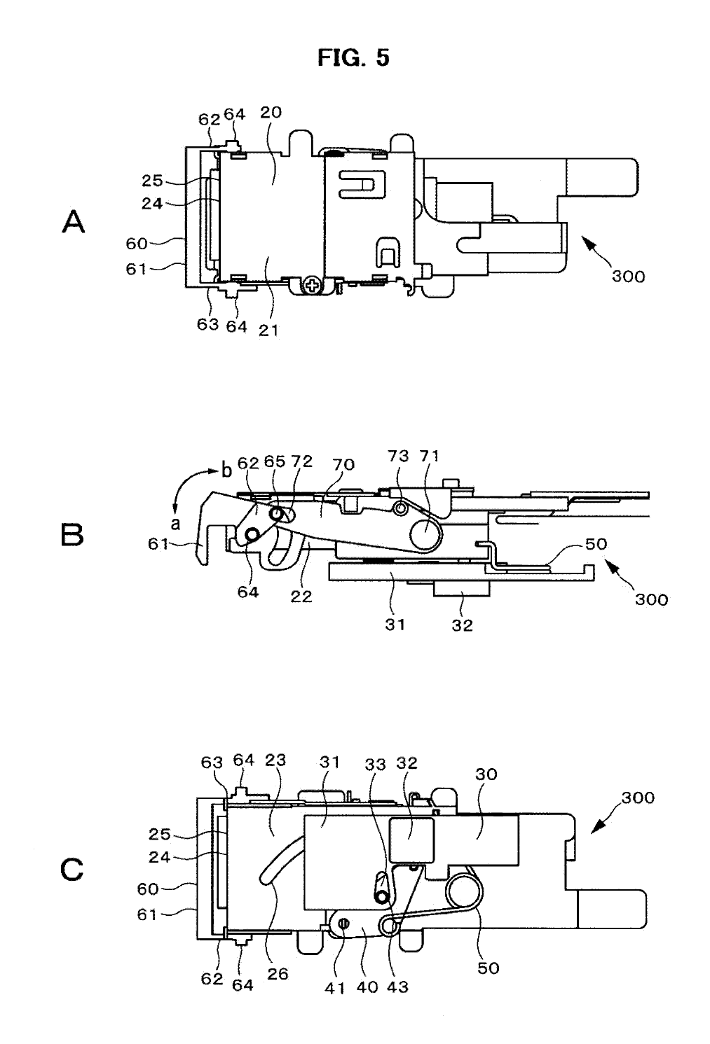

In addition, FIG. 5A is a top view of the terminal housing apparatus 300, FIG. 5B is a side view of the terminal housing apparatus 300, and FIG. 5C is a bottom view of the terminal housing apparatus 300.

The terminal housing apparatus 300 includes the terminal 10, a chassis 20, the tab 30, the terminal operating lever 40, the terminal spring 50, the cover 60, and the cover lever 70.

The chassis 20 includes the housing portion 24 for housing the terminal 10 and forms a base of the terminal housing apparatus 300. The tab 30 is operated by the user to extend the terminal 10 out of and retract the terminal 10 into the housing portion 24. The tab 30 corresponds to an “operation portion” mentioned in the range of the patent claims. The terminal operating lever 40 is provided so as to be interposed between the tab 30 and the terminal 10, and operates the terminal 10 in concert with an operation of the tab 30. The terminal spring 50 energizes the terminal operating lever 40 in a specified direction to operate the terminal operating lever 40.

The cover 60 closes an opening 25 of the housing portion 24. The cover lever 70 opens and closes the cover 60.

The chassis 20 forms a base of the terminal housing apparatus 300. The chassis 20 is composed of a top surface portion 21, a first side surface portion 22, a second side surface portion (not shown), and a bottom surface portion 23, and is formed as a substantially rectangular cylinder that is open at the front. The internal space formed by the top surface portion 21, the first side surface portion 22, the second side surface portion, and the bottom surface portion 23 functions as the housing portion 24 for housing the terminal 10. The housing portion 24 includes the opening 25. The terminal 10 slides inside the housing portion 24 and by doing so, the terminal 10 is extended outside the housing portion 24 from the opening 25. By sliding the terminal 10 inside the housing portion 24, the terminal 10 is also stored inside the housing portion 24 from the opening 25.

As shown in FIG. 4A, an arc-shaped groove 26 with a form that is curved into an arc is formed in the bottom surface portion 23 of the chassis 20. The terminal operating lever 40 for extending and retracting the terminal 10 is also provided on the bottom surface portion 23 of the chassis 20. The terminal operating lever 40 is supported at one end by a terminal lever rotational shaft 41 connected to the chassis 20 and is therefore capable of rotating in the directions shown as “c” and “d” about the terminal lever rotational shaft 41.

The terminal operating lever 40 is equipped with the terminal engagement protrusion 42 that protrudes toward the chassis 20 in a state where the terminal operating lever 40 is attached to the chassis 20. The terminal operating lever 40 is also equipped with a tab engagement protrusion 43 that protrudes in the opposite direction to the chassis 20 in a state where the terminal operating lever 40 is attached to the chassis 20.

The terminal engagement protrusion 42 is constructed so as to fit into the arc-shaped groove 26 formed in the bottom surface portion 23 of the chassis 20. In addition, as shown in FIGS. 4B and 4C, the terminal engagement protrusion 42 is constructed so as to also fit into the terminal lever engagement groove 16 of the cover portion 12 that constructs the terminal 10. Accordingly, the terminal engagement protrusion 42 is constructed so as to fit into both the arc-shaped groove 26 of the chassis 20 and the terminal lever engagement groove 16 of the cover portion 12 of the terminal 10.

The dimension from the terminal lever rotational shaft 41 to the terminal engagement protrusion 42 is set so as to be larger than the dimension from the terminal lever rotational shaft 41 to the tab engagement protrusion 43. By doing so, when the terminal operating lever 40 has rotated about the terminal lever rotational shaft 41, the moved distance of the terminal engagement protrusion 42 is larger than the moved distance of the tab engagement protrusion 43.

The terminal operating lever 40 is also connected to one end of the terminal spring 50, which is a two-pronged wire spring, by hooking on such end of the terminal spring 50. The other end of the terminal spring 50 is fixed to the chassis 20. The two-pronged terminal spring 50 has a continuous widening force that opens the arm parts of the terminal spring 50 toward the outside. Due to this force, the terminal operating lever 40 is continuously energized in the Direction e.

As shown in FIGS. 5B and 5C, the tab 30 includes a substrate 31 that slides on an inner surface (not shown) of the case 200 of the electronic appliance 100, a tab portion 32 that is provided on the substrate 31 and is in the form of a protrusion that is operated by the user, and a terminal lever engagement hole 33 formed in the substrate 31.

As shown in FIG. 5C, the tab 30 is constructed so that the tab engagement protrusion 43 provided on the terminal operating lever 40 is inserted into the terminal lever engagement hole 33. Note that the terminal lever engagement hole 33 is constructed with a predetermined length so as to allow the tab engagement protrusion 43 to move substantially perpendicular to the sliding direction of the terminal 10 in a state where the tab engagement protrusion 43 is inserted into the terminal lever engagement hole 33. The operation of the various component elements to extend and retract the terminal 10 will be described in detail later.

As shown in FIG. 1, the tab portion 32 in the form of a protrusion that is operated by the user is exposed from the tab exposure hole 240 to the outside. By doing so, the user becomes able to operate the tab 30.

The cover 60 that opens and closes the housing portion 24 is provided at the front of the chassis 20. The cover 60 is formed in substantially a U shape when viewed from above, and is composed of a cover portion 61 that opens and closes the housing portion 24, a first arm portion 62 that extends from one end of the cover portion 61 and is used to connect the cover 60 to the chassis 20, and a second arm portion 63 that extends from the other end of the cover portion 61 and is used to connect the cover 60 to the chassis 20.

Cover rotational shafts 64 are provided on the first arm portion 62 and the second arm portion 63 so as to protrude toward the inside. By inserting the cover rotational shafts 64 into the chassis 20, the cover 60 is rotatably connected to the chassis 20. A cover opening/closing protrusion 65 is also provided on the first arm portion 62 so as to protrude toward the inside.

In a state where the terminal 10 is housed in the housing portion 24, as shown in FIGS. 5B and 2A, the cover 60 rotates in the Direction a to close the housing portion 24. Meanwhile in a state where the terminal 10 protrudes outside the housing portion 24, the cover 60 rotates in the Direction b shown in FIGS. 5B and 2B to open the housing portion 24. Accordingly, the cover 60 opens and closes the terminal opening 220 of the case 200 to open and close the housing portion 24.

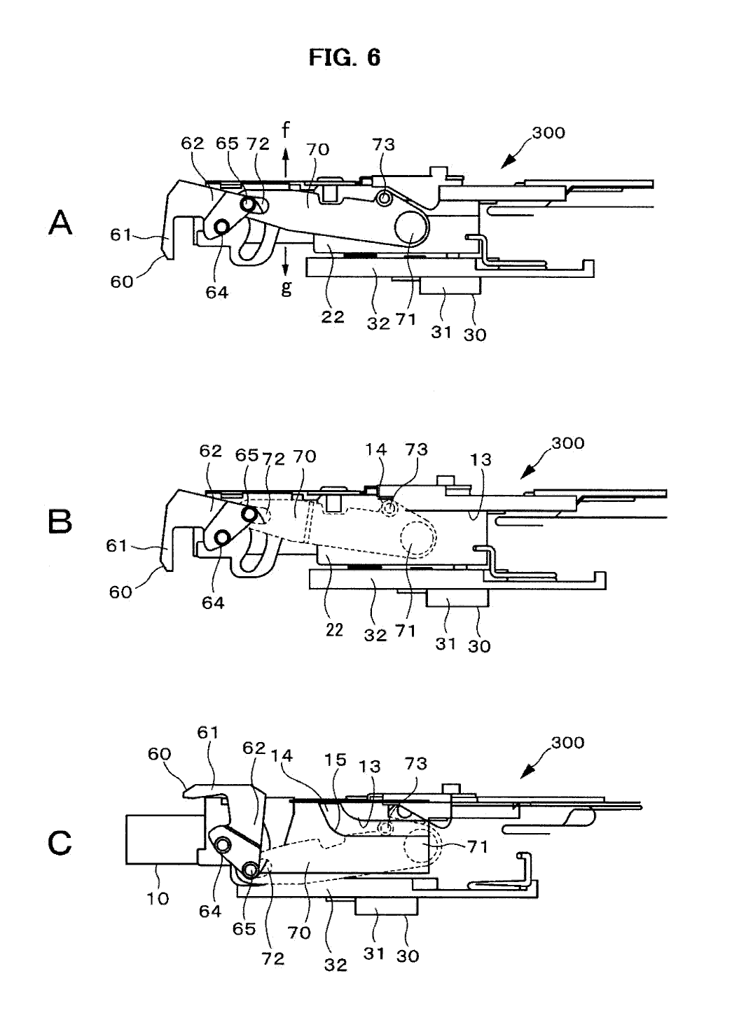

FIGS. 6A to 6C are side views of the terminal housing apparatus 300. FIG. 6A and FIG. 6B show a state where the terminal 10 is housed inside the housing portion 24. FIG. 6C is a side view of the terminal housing apparatus 300 showing a state during an extending/retracting operation of the terminal 10. Note that for ease of explanation, in FIGS. 6B and 6C, the first side surface portion 22 of the chassis 20 is omitted and the cover lever 70 is depicted as being transparent.

The cover lever 70 for opening and closing the cover 60 is provided on the first side surface portion 22 of the chassis 20. By being rotatably supported at one end on the chassis 20 by a cover lever rotational shaft 71, the cover lever 70 is constructed so as to be capable of moving in the Directions f and g about the cover lever rotational shaft 71.

A cover engagement hole 72 is formed at the other end of the cover lever 70. The cover opening/closing protrusion 65 provided on the first arm portion 62 that constructs the cover 60 is inserted into the cover engagement hole 72. By doing so, it is possible to operate the cover 60 in concert with an operation of the cover lever 70. By operating the cover lever 70 in the Direction f, the cover 60 is closed, and by operating the cover lever 70 in the Direction g, the cover 60 is opened. Note that the opening and closing operation of the cover 60 will be described in detail later.

The cover lever protrusion 73 that protrudes toward the chassis 20 in a state where the cover lever 70 is connected to the chassis 20 is provided on the cover lever 70. As shown in FIGS. 6B and 6C, the cover lever protrusion 73 is constructed so as to fit into and engage the cover lever engagement groove 13 formed in the cover portion 12 of the terminal 10. Note that a hole (not shown) that enables the cover lever protrusion 73 to protrude inside the housing portion 24 and fit into the cover lever engagement groove 13 is formed in the first side surface portion 22 of the chassis 20.

In a state where the terminal 10 is housed in the housing portion 24, the cover lever protrusion 73 is positioned in the concave portion 14 formed in the cover portion 12 of the terminal 10. Also, as shown in FIG. 6C, when the terminal 10 is sliding in the direction where the terminal 10 protrudes outside the housing portion 24, the cover lever protrusion 73 slides inside the cover lever engagement groove 13.

### 1-3. Operation of Terminal Housing Apparatus

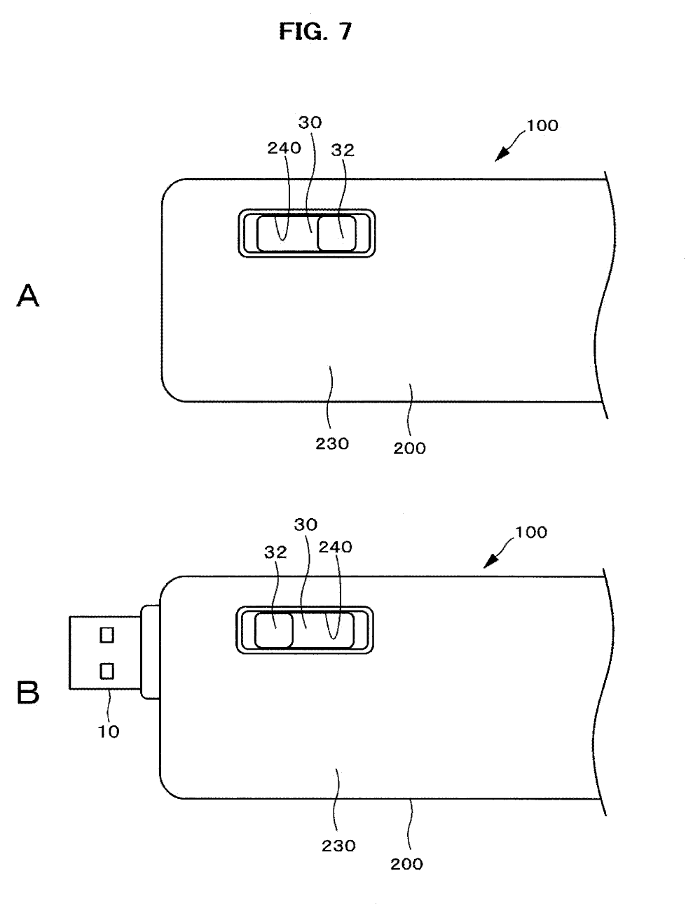

Next, the operation of the terminal housing apparatus 300 will be described. First, a case where the terminal 10 housed in the housing portion 24 is extended outside the housing portion 24 will be described. FIGS. 7A and 7B are partial enlarged views of the electronic appliance 100 that are useful in explaining an operation of the tab 30 by the user.

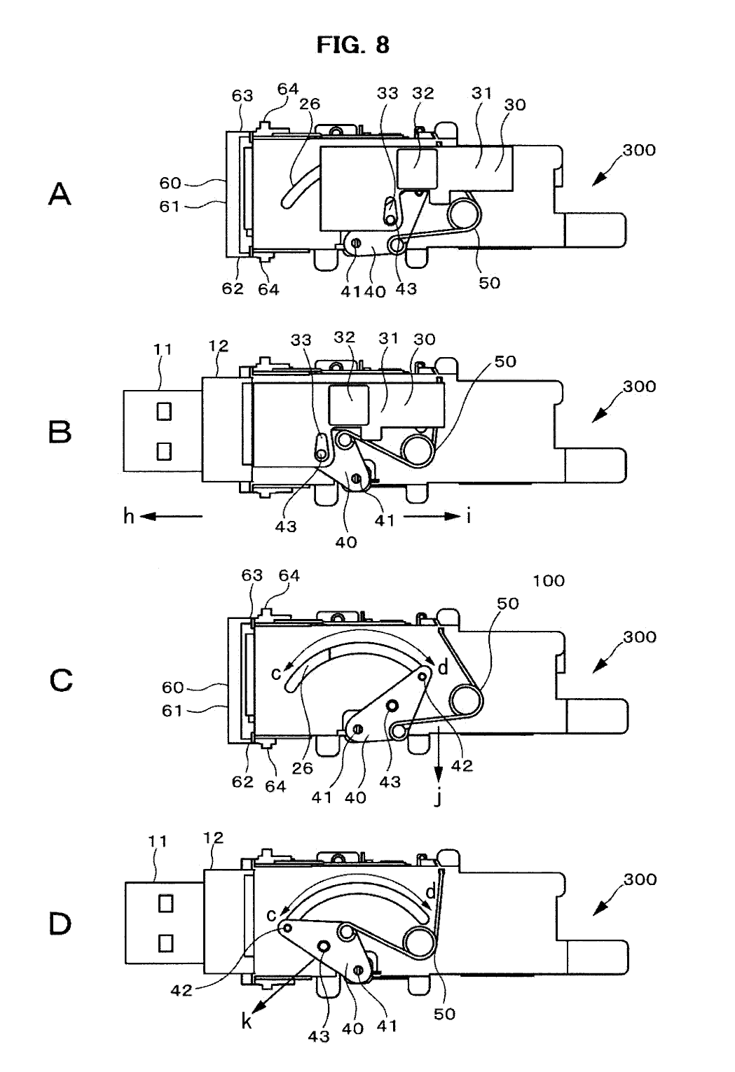

Also, FIGS. 8A to 8D are bottom views of the terminal housing apparatus 300 showing operation states of the terminal housing apparatus 300. FIGS. 8A and 8B are views showing states including the tab 30. FIGS. 8C and 8D are views showing states that omit the tab 30 for ease of explanation.

When extending the terminal 10, the user operates the tab portion 32 to slide the tab 30 from the state shown in FIG. 7A to the state shown in FIG. 7B. When this happens, the tab 30 slides in the Direction h from the state shown in FIG. 8A to the state shown in FIG. 8B.

By inserting the tab engagement protrusion 43 of the terminal operating lever 40 into the terminal lever engagement hole 33 formed in the substrate 31 of the tab 30, the tab 30 and the terminal operating lever 40 engage one another and become capable of operating in concert. Accordingly, if the tab 30 is slid in the Direction h, the tab 30 pulls the terminal operating lever 40 and the terminal operating lever 40 rotates in the Direction c about the terminal lever rotational shaft 41 from the state shown in FIG. 8C to the state shown in FIG. 8D.

Since the terminal operating lever 40 rotates about the terminal lever rotational shaft 41 without sliding in the same direction as the tab 30, the terminal engagement protrusion 42 moves in an arc. Accordingly, the arc-shaped groove 26 into which the terminal engagement protrusion 42 is inserted is formed so as to trace the rotational trajectory of the terminal engagement protrusion 42. The terminal engagement protrusion 42 moves in an arc along the arc-shaped groove 26.

The terminal engagement protrusion 42 engages the terminal lever engagement groove 16 of the cover portion 12 that constructs the terminal 10. Accordingly, when the terminal operating lever 40 rotates about the terminal lever rotational shaft 41, the terminal 10 is pulled in the Direction h by the terminal engagement protrusion 42. By doing so, the terminal 10 slides in the Direction h inside the housing portion 24 and is pulled out of the housing portion 24.

The terminal operating lever 40 is continuously energized by the widening force of the terminal spring 50. As shown in FIG. 8C, in a state where the terminal 10 is housed inside the housing portion 24, the terminal operating lever 40 is continuously energized in the Direction j by the terminal spring 50.

Meanwhile, when the terminal operating lever 40 rotates in concert with the sliding of the tab 30 and the terminal engagement protrusion 42 reaches substantially a midpoint of the arc-shaped groove 26, as shown in FIG. 8D, the terminal operating lever 40 becomes energized in the Direction k by the tension of the terminal spring 50. This means that if the terminal engagement protrusion 42 is moved to substantially the midpoint of the arc-shaped groove 26 due to the user sliding the tab 30, the terminal operating lever 40 will rotate thereafter due to the opening force of the terminal spring 50 and the terminal engagement protrusion 42 will move to the end of the arc-shaped groove 26. Therefore, if the user slides the tab 30 to a position where the terminal 10 reaches substantially the midpoint of the arc-shaped groove 26, it will be possible to have the terminal 10 pulled out of the housing portion 24 without adding any force thereafter.

The terminal operating lever 40 is constructed so that the dimension from the terminal lever rotational shaft 41 to the terminal engagement protrusion 42 is larger than the dimension from the terminal lever rotational shaft 41 to the tab engagement protrusion 43. By doing so, the distance moved by the terminal engagement protrusion 42 due to rotation of the terminal operating lever 40 is longer than the distance moved by the tab engagement protrusion 43 due to rotation of the terminal operating lever 40.

Accordingly, by sliding the tab 30 to rotate the terminal operating lever 40 and move the tab engagement protrusion 43, the user is capable of moving the terminal engagement protrusion 42 by a longer distance than the distance moved by the tab engagement protrusion 43. By doing so, it is possible to move the terminal 10 by a longer distance than the sliding distance of the tab 30. Accordingly, when sliding the terminal 10 to extend the terminal 10 out of the housing portion 24, it is not necessary for the user to slide the tab 30 by the same distance as the distance slid by the terminal 10. That is, by sliding the tab 30, it is possible to cause the terminal 10 to slide by a greater distance than the distance slid by the tab 30.

By doing so, the distance moved by the user's finger that operates the tab when extending and retracting the terminal 10 is reduced, which makes it faster and easier to extend and retract the terminal 10. Also, since the range of the tab 30 on the electronic appliance 100 and the terminal housing apparatus 300 can be reduced, it is possible to increase the design freedom of the electronic appliance 100.

Note that the terminal lever engagement hole 33 formed in the substrate 31 of the tab 30 is formed with a specified length in a direction substantially perpendicular to the sliding direction of the terminal 10. This is to provide some play for rotational operations of the terminal operating lever 40. That is, since the terminal operating lever 40 rotates about the terminal lever rotational shaft 41 and the tab engagement protrusion 43 also rotates about the terminal lever rotational shaft 41 in the Directions c and d, it would not be possible for the terminal operating lever 40 to rotate if no play were provided at the engagement hole.

As shown in FIG. 8D, in the state where the terminal 10 is extended outside the housing portion 24, the terminal spring 50 continuously energizes the terminal operating lever 40 in the Direction k. By doing so, it is possible to prevent the terminal 10 from being pressed from the outside in the Direction i (the direction where the terminal 10 becomes stored away) and returning in the direction of the housing portion 24.

Also, as shown in FIG. 4C, in a state where the terminal 10 is extended outside the housing portion 24, the terminal engagement protrusion 42 of the terminal operating lever 40 is positioned at the terminal lever fixing portion 17. By doing so, even if the terminal 10 is pressed from the outside in the Direction i (the direction in which the terminal 10 becomes stored away), the form of the terminal lever fixing portion 17 will push against the terminal engagement protrusion 42 and the pressing in the Direction i (the direction in which the terminal 10 is stored away) will be canceled out by the energizing of the terminal operating lever 40 in the Direction k, thereby making it possible to prevent the terminal 10 from returning in the direction of the housing portion 24.

By doing so, as one example, when the terminal 10 is connected to a peripheral device such as a personal computer, it is possible to prevent the terminal 10 from returning back inside the housing portion 24, which would prevent insertion of the terminal 10 into the peripheral device.

Next, a case where the terminal 10 that is extended is stored away inside the housing portion 24 will be described. When storing the terminal 10, the user operates the tab portion 32 to move from the state shown in FIG. 7B to the state shown in FIG. 7A. When this happens, the tab 30 slides in the Direction i from the state shown in FIG. 8B to the state shown in FIG. 8A.

By inserting the tab engagement protrusion 43 of the terminal operating lever 40 into the terminal lever engagement hole 33 formed in the substrate 31 of the tab 30, the tab 30 engages the terminal operating lever 40 so that the terminal operating lever 40 moves in concert with the tab 30. Accordingly, when the tab 30 slides in the Direction i, the tab 30 pulls the terminal operating lever 40 and the terminal operating lever 40 rotates about the terminal lever rotational shaft 41 in the Direction d from the state shown in FIG. 8D to the state shown in FIG. 8C.

Since the terminal engagement protrusion 42 fits into a groove in the cover portion 12 that constructs the terminal 10, when the terminal operating lever 40 rotates in the Direction d about the terminal lever rotational shaft 41, the terminal 10 is pulled in the Direction i in concert with the movement of the terminal engagement protrusion 42. By doing so, the terminal 10 is stored inside the housing portion 24.

The terminal operating lever 40 is continuously energized by the widening force of the terminal spring 50. As shown in FIG. 8D, in a state where the terminal 10 is extended outside the housing portion 24, the terminal operating lever 40 is continuously energized by the terminal spring 50 in the Direction k.

Meanwhile, once the terminal operating lever 40 has rotated in concert with the sliding of the tab 30 and the terminal engagement protrusion 42 has reached substantially the midpoint on the arc-shaped groove 26, as shown in FIG. 8C, the terminal operating lever 40 becomes energized in the Direction j by the tension of the terminal spring 50. By doing so, if the user slides the tab 30 to move the terminal engagement protrusion 42 to substantially the midpoint of the arc-shaped groove 26, the terminal operating lever 40 will thereafter rotate due to the widening force of the terminal spring 50 and the terminal engagement protrusion 42 will move to the end (i.e., the end in the Direction d) of the arc-shaped groove 26. Accordingly, if the user slides the tab 30 to a position where the terminal 10 reaches substantially the midpoint of the arc-shaped groove 26, it will be possible to have the terminal 10 stored inside the housing portion 24 without adding any force thereafter.

Note that the terminal operating lever 40 is constructed so that the dimension from the terminal lever rotational shaft 41 to the terminal engagement protrusion 42 is larger than the dimension from the terminal lever rotational shaft 41 to the tab engagement protrusion 43. By doing so, when the terminal 10 is stored away, in the same way as when the terminal 10 is extended, by sliding the tab 30, it is possible to slide the terminal 10 by a greater distance than the distance slid by the tab 30. Accordingly, the distance moved by the user's finger that operates the tab when storing the terminal 10 is reduced, which makes storing away the terminal 10 faster and easier.

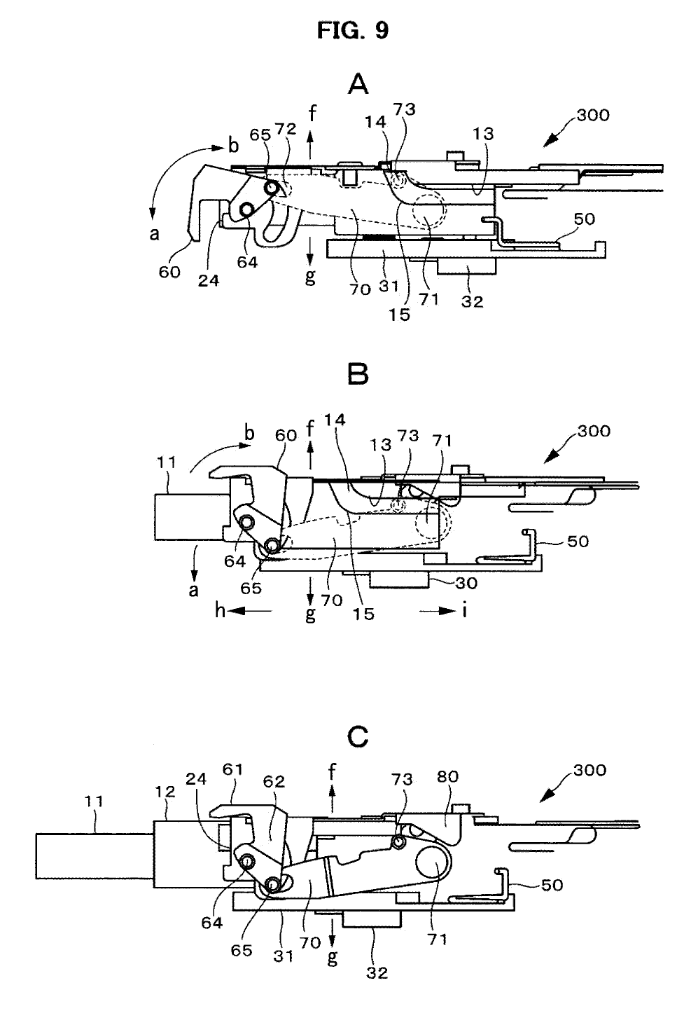

Next, the operation that opens the cover 60 in keeping with an operation that extends the terminal 10 will be described. FIGS. 9A to 9C are side views of the terminal housing apparatus 300 showing operational states of the terminal housing apparatus 300. FIG. 9A shows a state where the terminal 10 is housed inside the housing portion 24 and the cover 60 is closed. FIG. 9B shows a state during an operation that extends the terminal 10 from the housing portion 24 toward the outside. FIG. 9C shows a state where the terminal 10 has been extended from the housing portion 24. Note that for ease of explanation, the first side surface portion 22 of the chassis 20 is omitted from FIGS. 9A and 9B and the cover lever 70 is depicted in a transparent state.

When the terminal 10 is stored inside the housing portion 24, the cover 60 closes the housing portion 24. In this state, as shown in FIG. 9A, the cover lever protrusion 73 provided on the cover lever 70 is positioned at the concave portion 14 provided on the cover portion 12 of the terminal 10.

When extending the terminal 10, the user operates the tab portion 32 from the state shown in FIG. 7A to the state shown in FIG. 7B. When this happens, the tab 30 slides in the Direction h from the state shown in FIG. 9A to the state shown in FIG. 9B.

At this time, from the state shown in FIG. 9A, the cover lever protrusion 73 of the cover lever 70 that was positioned in the concave portion 14 moves downward along the curved surface portion 15 formed as a curved surface and as shown in FIG. 9B enters the cover lever engagement groove 13 along the curved surface portion 15. This causes the cover lever 70 to rotate about the cover lever rotational shaft 71 in the Direction g.

As a result, as shown in FIG. 9B, the front end of the cover lever 70 where the cover engagement hole 72 is formed is lowered. By doing so, the cover opening/closing protrusion 65 that engages the cover engagement hole 72 is pulled and the cover 60 rotates in the Direction b about the cover rotational shafts 64 to open the cover 60.

After this, the terminal 10 is pulled out from the housing portion 24 and once the terminal 10 is extended, as shown in FIG. 9C, the cover lever protrusion 73 of the cover lever 70 comes out of the cover lever engagement groove 13.

In this way, when the user slides the tab 30 and causes the terminal 10 to move out from the housing portion 24, the cover 60 also opens, which means that the user does not need to carry out a separate operation to open the cover 60.

Next, an operation that closes the cover 60 in concert with an operation that stores the terminal 10 in the housing portion 24 will be described. When storing the terminal 10, the user operates the tab portion 32 from the state shown in FIG. 7B to the state shown in FIG. 7A. When this happens, the tab 30 slides from the state shown in FIG. 8B to the state shown in FIG. 8A in the Direction i. As a result, the cover lever protrusion 73 of the cover lever 70 enters the cover lever engagement groove 13 from the state shown in FIG. 9C to the state shown in FIG. 9B.

In concert with the tab 30 sliding in the Direction i, the terminal 10 slides in the Direction i, the cover lever protrusion 73 reaches the curved surface portion 15 and the cover lever protrusion 73 moves upward along the curved surface of the curved surface portion 15 to enter the concave portion 14. By doing so, the front end of the cover lever 70 is lifted in the Direction f.

At this time, the cover engagement hole 72 of the cover lever 70 pulls the cover opening/closing protrusion 65 provided on the first arm portion 62 of the cover 60 in the Direction f so that the cover 60 rotates about the cover rotational shafts 64 in the Direction a. By doing so, the cover 60 is closed as shown in FIG. 9A. In this way, the cover 60 is closed in concert with the operation that stores the terminal 10 in the housing portion 24, which means that the user does not need to carry out a separate operation to close the cover 60. Note that it is possible to realize the same operation even if the cover lever 70 is energized in the Direction f by an elastic body such as a spring. However, if a configuration such as that shown in the present embodiment is used where the cover lever protrusion 73 is raised along a curved surface of the curved surface portion 15 to cause the cover lever 70 to rotate and thereby raise the front end of the cover lever 70, an elastic body such as a spring is unnecessary. By doing so, it is possible to reduce the number of components and thereby reduce both cost and weight.

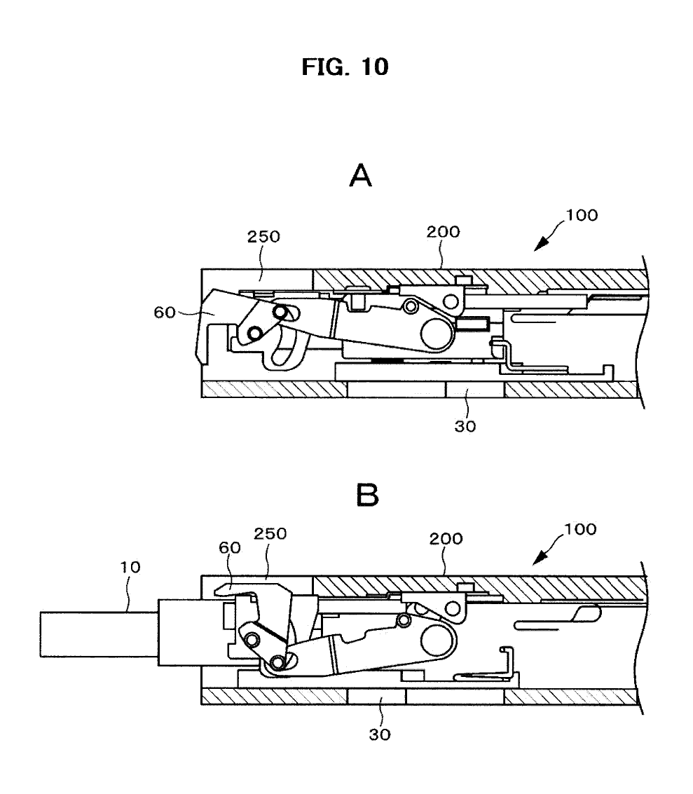

Note that as shown in FIG. 10A, a cover housing portion 250 for storing the cover 60 is formed inside the case 200. When the cover 60 is in the open state, as shown in FIG. 10B, the cover 60 is stored inside the cover housing portion 250. Accordingly, the cover 60 does not protrude outside the electronic appliance 100.

By doing so, it is possible to prevent the user from accidentally breaking the cover 60. Also, since the cover 60 does not appear on the surface of the electronic appliance 100, it is possible to increase the design freedom of the electronic appliance 100.

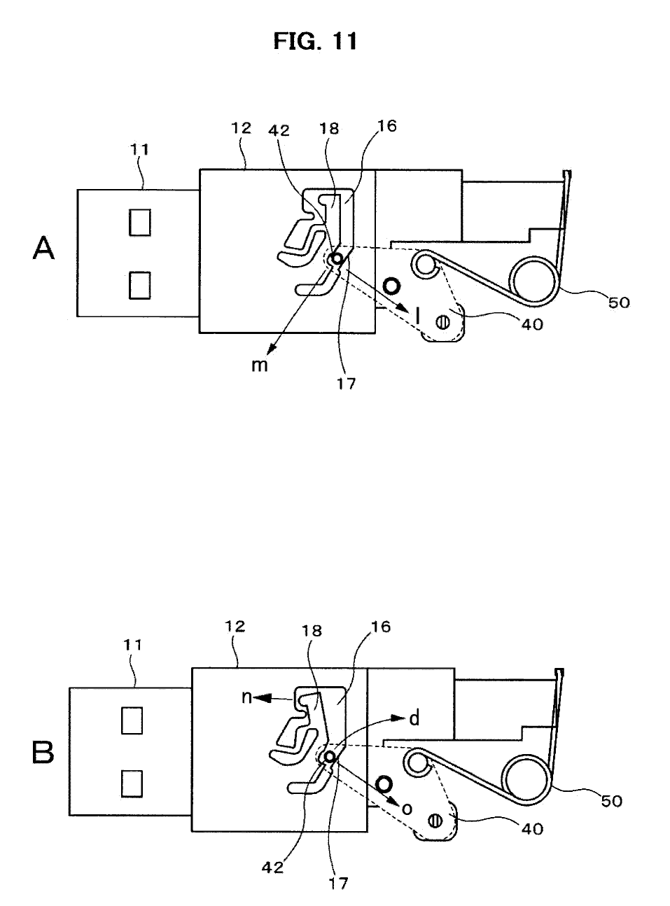

Note that if the terminal 10 is pressed from outside in a state where the terminal 10 is extended outside the housing portion 24, as shown in FIG. 11A, the terminal engagement protrusion 42 will be energized in the Direction 1 due to the angle made by the terminal lever fixing portion 17 to the terminal lever engagement groove 16. As a result, the terminal operating lever 40 becomes energized in the Direction m. The Direction m is the opposite direction to the direction in which the terminal operating lever 40 is trying to rotate. Accordingly, even if the terminal 10 is pressed from outside, the terminal 10 will not move and become stored inside the housing portion 24. In other words, the terminal 10 is locked in the extended state.

Meanwhile, a situation can be imagined where a strong shock is received in the direction where the terminal 10 is stored inside the housing portion 24 so that the terminal 10 is pressed with a large force. Here, the expression “large force” refers to a force that is larger than the force applied to the electronic appliance 100 when the user connects the terminal 10 to a peripheral appliance, and is an extremely large force such as the shock caused when the electronic appliance 100 is dropped.

When a large force is applied to the terminal, as shown in FIG. 11B, the rib portion 18 becomes inclined in the Direction n so that the angle made to the terminal lever fixing portion 17 changes. In this way, the rib portion 18 is provided so that the angle to the terminal lever fixing portion 17 is variable. Due to the angle to the terminal lever fixing portion 17 changing, the terminal engagement protrusion 42 becomes energized in the Direction o by the large force from the outside and the terminal operating lever 40 rotates in the Direction d. As a result, the terminal 10 becomes stored inside the housing portion 24. In this way, since the terminal 10 is pulled inside the housing portion 24 when a large force is applied to the terminal 10 from outside, it is possible to prevent breakage of the terminal 10 and also the various parts that construct the terminal housing apparatus 30.

### 2. Modifications

Although a specific embodiment of the present disclosure has been described above, the present disclosure is not limited to the above embodiment. It should be understood by those skilled in the art that various modifications, combinations, sub-combinations and alterations may occur depending on design requirements and other factors insofar as they are within the scope of the appended claims or the equivalents thereof.

Although an example where the electronic appliance 100 is a so-called “USB memory” has been described in the above embodiment, the electronic appliance 100 is not limited to a USB memory and may be a voice recorder equipped with a USB terminal. The electronic appliance 100 may be a digital still camera, a digital video camera, a mobile phone, a smartphone, a mobile game console or the like equipped with a USB terminal. The present disclosure can be applied to any appliance equipped with a terminal.

Also, the terminal is not limited to a USB terminal and may be a terminal that conforms to HDMI (High-Definition Multimedia Interface) standard, a terminal that conforms to S/PDIF (Sony Philips Digital InterFace) standard, a terminal that conforms to FIREWIRE standard, or the like. That is, the present disclosure can be applied to all types of terminal.

Additionally, the present technology may also be configured as below.

(1) A terminal housing apparatus including:

a housing portion that is provided with an opening and houses a terminal;

a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion; and

an operation portion that engages the terminal operating lever and is operable to rotate the terminal operating lever when operated by a user.

(2) A terminal housing apparatus according to (1),

wherein the terminal operating lever includes an engagement protrusion that engages the terminal at the other end of the terminal operating lever, and

a dimension from a position where the terminal operating lever is rotatably supported to the engagement protrusion is longer than a dimension from the position where the terminal operating lever is rotatably supported to a position where the terminal operating lever engages the operation portion.

(3) A terminal housing apparatus according to (1),

wherein in a state where the terminal is extended outside the housing portion, the terminal operating lever is energized in the first direction by an elastic body, and in a state where the terminal is housed inside the housing portion, the terminal operating lever is energized in the second direction by the elastic body.

(4) A terminal housing apparatus according to any one of (1) to (3),

wherein the terminal includes an engagement groove that is substantially perpendicular to a direction in which the terminal operates,

the terminal operating lever and the terminal engage one another due to the engagement protrusion being inserted into the engagement groove.

(5) A terminal housing apparatus according to any one of (1) to (4),

wherein a curved surface portion is formed at one end of the engagement groove, and in a state where the terminal is extended outside the housing portion, the engagement protrusion is positioned inside the curved surface portion.

(6) A terminal housing apparatus according to any one of (1) to (5),

further comprising a cover that opens and closes the opening.

(7) An electronic appliance including:

a terminal housing apparatus including a housing portion that is provided with an opening for extending and retracting a terminal and houses the terminal, a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion, and an operation portion that engages the terminal operating lever and is operable to rotate the terminal operating lever when operated by a user; and

a case housing the terminal housing apparatus.

The present disclosure contains subject matter related to that disclosed in Japanese Priority Patent Application JP 2011-160423 filed in the Japan Patent Office on Jul. 22, 2011, the entire content of which is hereby incorporated by reference.

What is claimed is:

1. A terminal housing apparatus comprising:
a housing portion that is provided with an opening and houses a terminal;
a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion; and
an operation portion that engages the terminal operating lever and is operable to rotate the terminal operating lever when operated by a user.

2. A terminal housing apparatus according to claim 1,
wherein the terminal operating lever includes an engagement protrusion that engages the terminal at the other end of the terminal operating lever, and
a dimension from a position where the terminal operating lever is rotatably supported to the engagement protrusion is longer than a dimension from the position where the terminal operating lever is rotatably supported to a position where the terminal operating lever engages the operation portion.

3. A terminal housing apparatus according to claim 2,
wherein in a state where the terminal is extended outside the housing portion, the terminal operating lever is energized in the first direction by an elastic body, and in a state where the terminal is housed inside the housing portion, the terminal operating lever is energized in the second direction by the elastic body.

4. A terminal housing apparatus according to claim 2,
wherein the terminal includes an engagement groove that is substantially perpendicular to a direction in which the terminal operates,
the terminal operating lever and the terminal engage one another due to the engagement protrusion being inserted into the engagement groove.

5. A terminal housing apparatus according to claim 2,
wherein a curved surface portion is formed at one end of the engagement groove, and in a state where the terminal is extended outside the housing portion, the engagement protrusion is positioned inside the curved surface portion.

6. A terminal housing apparatus according to claim 1,
further comprising a cover that opens and closes the opening.

7. An electronic appliance comprising:
a terminal housing apparatus including a housing portion that is provided with an opening for extending and retracting a terminal and houses the terminal, a terminal operating lever that is rotatably supported at one end thereof, engages the terminal at another end thereof, moves the terminal in a first direction so as to extend the terminal outside the housing portion, and moves the terminal in a second direction so as to store the terminal in the housing portion, and an operation portion that engages the terminal operating lever and is operable to rotate the terminal operating lever when operated by a user; and
a case housing the terminal housing apparatus.

8. An electronic appliance according to claim 7,
wherein the terminal housing apparatus further includes a cover opening and closing the opening, and
the case includes a cover housing portion in which the cover is housed when the opening is in an opened state.
